(19) United States
(12) Patent Application Publication
(10) Pub. No.: US 2009/0213960 A1
(43) Pub. Date: Aug. 27, 2009

(54) TRANSMITTER

(75) Inventors: Takeshi IKEDA, Tokyo (JP); Hiroshi MIYAGI, Yokohama-Shi (JP)

Correspondence Address: CONNOLLY BOVE LODGE & HUTZ LLP, 1875 EYE STREET, N.W., SUITE 1100, WASHINGTON, DC, 20006, US

(73) Assignee: NSC CO., LTD., Tokyo (JP)

(21) Appl. No.: 12/392,825

(22) Filed: Feb. 25, 2009

(30) Foreign Application Priority Data
Feb. 26, 2008 (JP) 2008-044008

(51) Int. Cl. H04L 27/36; H04L 25/49; H04L 27/00

(52) U.S. Cl. 375/296; 375/298

(57) ABSTRACT

There are provided a BPF (15) for extracting an image frequency component from a modulating signal generated by modulating I and Q signals through a quadrature modulating portion (3), an energy detecting portion (16) for detecting an energy of the image frequency component, and an amplitude correcting portion (12) and a phase correcting portion (13) which correct an amplitude and a phase of the I signal to minimize the detected energy. By correcting the amplitude and the phase to minimize the energy of the image frequency component contained in the generated modulating signal without detecting amplitude and phase errors themselves of the I and Q signals, it is possible to accurately correct the amplitude and phase errors of the I and Q signals without an influence of a limit of precision in an error detection.

### BACKGROUND OF THE INVENTION

1. Field of the Invention

The present invention relates to a transmitter, and more particularly to a transmitter having a quadrature modulating function for distributing a baseband signal into an in-phase component and a quadrature component to carry out a modulation.

2. Description of the Related Art

In order to transmit information as a wireless electric wave signal, generally, a so-called modulation processing for converting a baseband signal (a low frequency signal containing a DC vicinal component) into a radio frequency signal is indispensable. Conventionally, a frequency modulating method having a resistant property to a noise on a transmission path has been used often when a stereo audio signal is to be transmitted by wireless. Other modulating methods include a quadrature modulation (IQ modulation) for distributing a baseband signal into an I channel (an in-phase component) and a Q channel (a quadrature component) to carry out a modulation (for example, see Patent Document 1).

Patent Document 1: Japanese Laid-Open Patent Publication No. 5-136836

FIG. 4 is a diagram showing a structure of a quadrature modulating device described as the prior art in the Patent Document 1. In FIG. 4, input L (left) and R (right) audio data strings are processed by a signal processing portion 101 and are separated into I and Q channel signals. The I and Q signals thus separated are processed by digital filters 102a and 102b, D/A converters 103a and 103b, and low-pass filters 104a and 104b, and an output of a local oscillator 105 and that of a 90° phase shifter 107 are then subjected to mixing by mixers 106a and 106b. Thereafter, the I and Q signals subjected to the mixing are added by an adder 108, and a signal output from the adder 108 is processed by a frequency converter 109 and a level regulator 110 so that a radio frequency modulating signal is output.

With the structure in FIG. 4, the mixers 106a and 106b and the 90° phase shifter 107 are constituted by analog circuits. For this reason, an amplitude error is made between the I and Q signals due to a variation in an analog element or the like, and a phase difference is not accurately 90° in some cases. However, there is a problem in that an image component is caused to occur in the mixers 106a and 106b due to the amplitude error or phase error between the I and Q signals if the mixers 106a and 106b and the 90° phase shifter 107 are not ideal.

In order to cope with the problem, the invention described in the Patent Document 1 has proposed a structure in which amplitude and phase errors between I and Q signals are detected and corrected to remove an image component caused by the errors. More specifically, in the Patent Document 1, an error detecting signal which does not influence a modulating signal is subjected to a quadrature modulation and an image component of the error detecting signal is extracted from a quadrature modulating signal thus obtained, and the image component is processed to generate amplitude and phase error signals. By using each of the error signals, an amplitude and a phase are regulated in such a manner that the image component is decreased.

### DISCLOSURE OF THE INVENTION

In the prior art described in the Patent Document 1, however, the amplitude and phase errors themselves of the I and Q signals are detected and corrected. For this reason, if precision in a detection of the error is poor, amplitudes of the I and Q signals cannot be accurately coincident with each other and the phase error cannot be accurately set to be 90°. In order to ensure a high image removing ratio, it is necessary to reduce the amplitude and phase errors to have very small values or less. However, it is hard to ensure precision for detecting such small errors. For this reason, there is a problem in that it is impossible to accurately carry out an amplitude correction or a phase correction.

Due to a variation in an analog element or the like, it is hard to constitute a signal processing system including the D/A converter 103a, the low-pass filter 104a and the mixer 106a and a signal processing system including the D/A converter 103b, the low-pass filter 104b and the mixer 106b to have a perfectly symmetrical type. For this reason, there is also a problem in that a carrier leakage is caused by the imbalance.

In order to solve the problems, it is an object of the present invention to accurately correct phase and amplitude errors of I and Q signals, thereby suppressing an image component effectively.

Moreover, it is another object of the present invention to effectively suppress an occurrence of a carrier leakage based on an imbalance of two signal processing systems.

In order to attain the objects, in the present invention, an image frequency component is extracted from a modulating signal generated by modulating an in-phase signal and a quadrature signal with a carrier signal and an amplitude and a phase are corrected for at least one of the in-phase signal and the quadrature signal in such a manner that an energy of the image frequency component is minimized.

In another aspect of the present invention, a carrier frequency component is extracted by using a modulating signal generated by a mixer portion and a DC offset correction is carried out over at least one of the in-phase signal and the quadrature signal in such a manner that an energy of the carrier frequency component is minimized.

In the present invention having the structure described above, the energy of the image frequency component is minimized when the amplitudes of the in-phase signal and the quadrature signal are coincident with each other and the phase difference therebetween is 90°. By regulating the amplitude and the phase to minimize the energy, therefore, it is possible to eliminate the amplitude error and the phase error between the in-phase signal and the quadrature signal as a result. Consequently, it is not necessary to detect the amplitude and phase errors themselves between the in-phase signal and the quadrature signal, and it is possible to accurately correct the amplitude and phase errors caused by a variation in an analog element in a 90° phase shifter, a mixer or the like, thereby enhancing the effect for removing the image component.

According to another aspect of the present invention, a DC offset is regulated to minimize the energy of the carrier frequency component. As a result, the DC offset of the carrier frequency component is suppressed to be eliminated. Thus, it is possible to effectively prevent a carrier leakage from occurring.

### BRIEF DESCRIPTION OF THE DRAWINGS

FIG. 1 is a diagram showing an example of a structure of a transmitter according to a first embodiment,

FIG. 2 is a chart for explaining a frequency shift to be carried out by a 90° C. phase shifter and a mixer according to first and second embodiments,

FIG. 3 is a diagram showing an example of a structure of a transmitter according to the second embodiment, and

FIG. 4 is a diagram showing an example of a structure of a conventional transmitter.

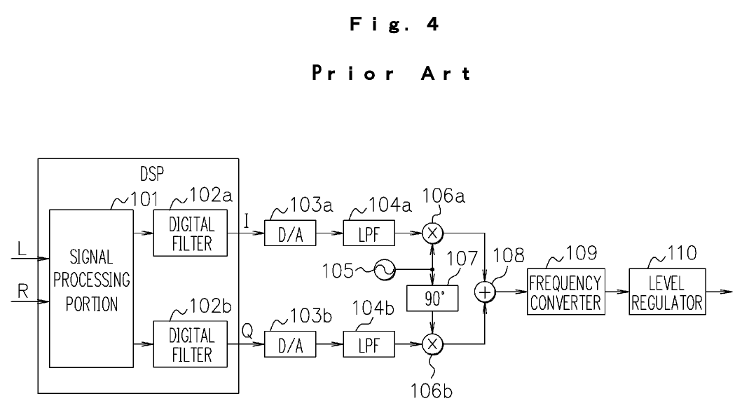

### DETAILED DESCRIPTION OF THE PREFERRED EMBODIMENTS

### First Embodiment

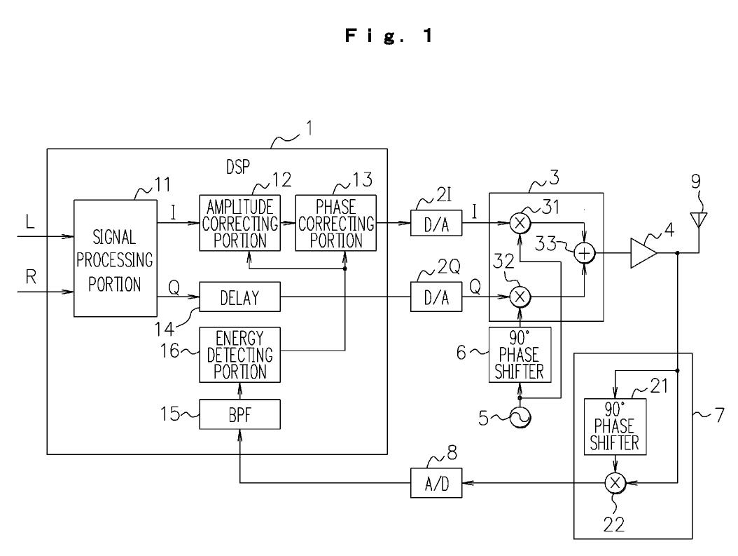

An embodiment according to the present invention will be described below with reference to the drawings. FIG. 1 is a diagram showing an example of a structure of a transmitter according to a first embodiment. As shown in FIG. 1, a transmitter according to the first embodiment includes a DSP (Digital Signal Processor) 1, D/A converting portions 2I and 2Q, a quadrature modulating portion 3, a power amplifier 4, a local oscillator 5, a 90° phase shifter 6, a detecting portion 7, an A/D converting portion 8 and a transmitting antenna 9.

The DSP 1 corresponds to a digital signal processing circuit according to the present invention and includes a signal processing portion 11, an amplitude correcting portion 12, a phase correcting portion 13, a delay processing portion 14, a band-pass filter (BPF) 15 and an energy detecting portion 16 as a functional structure implemented by a signal processing.

The signal processing portion 11 generates an in-phase signal (I signal) and a quadrature signal (Q signal) having a perpendicular phase thereto. For example, the signal processing portion 11 generates a stereo composite signal from digital L (left) and R (right) channel signals input from an outside of the DSP 1. Then, an IQ modulation is applied to the stereo composite signal through a baseband frequency shift (for example, 0 to 75 kHz) so that the I and Q signals are generated.

The amplitude correcting portion 12 and the phase correcting portion 13 correspond to a correcting portion according to the present invention and correct an amplitude and a phase of the I signal generated by the signal processing portion 11, for example, in such a manner that an energy detected by the energy detecting portion 16 is minimized. The delay processing portion 14 delays the Q signal by an equal delay time to a delay time required for carrying out the amplitude and phase correction processings over the I signal through the amplitude correcting portion 12 and the phase correcting portion 13.

The D/A converting portions 2I and 2Q convert the I and Q signals generated in the DSP 1 from digital signals to analog signals. The quadrature modulating portion 3 corresponds to a mixer portion according to the present invention and frequency-mixes the I and Q signals generated in the DSP 1 and converted into the analog signals through the D/A converting portions 2I and 2Q with an in-phase carrier signal output from the local oscillator 5 and a quadrature carrier signal output from the 90° phase shifter 6, thereby generating a modulating signal having a desirable frequency (for example, an FM frequency band).

The quadrature modulating portion 3 includes two mixers 31 and 32 and an adder 33. The first mixer 31 modulates the I signal supplied from the D/A converting portion 2I with an in-phase carrier signal cos ωt supplied from the local oscillator 5 and outputs a result to the adder 33. The second mixer 32 modulates the Q signal supplied from the D/A converting portion 2Q with a quadrature carrier signal sin ωt supplied from the 90° phase shifter 6 and outputs a result to the adder 33. The adder 33 synthesizes the I and Q signals modulated by the mixers 31 and 32 and outputs an FM modulating signal having a desirable frequency.

The power amplifier 4 amplifies the FM modulating signal output from the quadrature modulating portion 3 and transmits the amplified signal through the transmitting antenna 10. The local oscillator 5 generates an in-phase local oscillating signal having a predetermined frequency and outputs the same local oscillating signal to the 90° phase shifter 6 and the first mixer 31. The 90° phase shifter 6 shifts a phase of the local oscillating signal output from the local oscillator 5 by 90° to generate a quadrature local oscillating signal, and outputs the same quadrature local oscillating signal to the second mixer 32.

The detecting portion 7 provided on an output side of the power amplifier 4 includes a 90° phase shifter 21 and a mixer 22. The 90° phase shifter 21 shifts a phase of the FM modulating signal generated by the quadrature modulating portion 3 and amplified by the power amplifier 4 by 90° and outputs a signal thus obtained. The mixer 22 corresponds to a second mixer portion according to the present invention and frequency-mixes the FM modulating signal generated by the quadrature modulating portion 3 and amplified by the power amplifier 4 with the FM modulating signal output from the 90° phase shifter 21, thereby converting the FM modulating signal generated in the quadrature modulating portion 3 into a signal having a baseband frequency (which will be hereinafter referred to as a baseband signal) and outputting the baseband signal thus obtained. More specifically, the detecting portion 7 frequency-converts the FM modulating signal generated in the quadrature modulating portion 3 with its own signal having a phase shifted by 90°, thereby converting a modulating signal in an FM frequency band into a baseband signal which is almost close to a direct current.

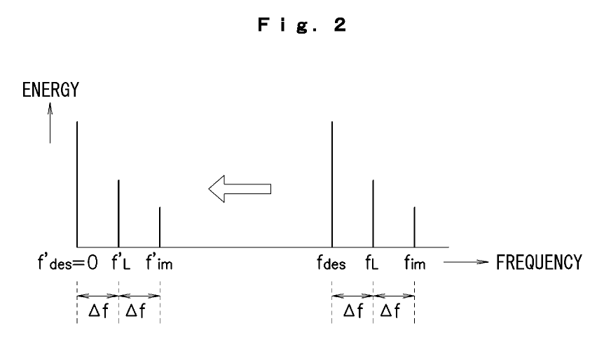

FIG. 2 is a chart for explaining a frequency shift to be carried out by the mixer 22. In FIG. 2, f_{des} denotes a desirable frequency of the FM modulating signal output from the power amplifier 4. f_{L} denotes a local frequency (a local oscillating frequency) of the carrier signal output from the local oscillator 5. fᵢₙ denotes a frequency of an image component caused to occur in a frequency channel having a certain frequency relationship with the desirable frequency f_{des} and the local oscillating frequency f_{L}.

As is well known, the image component is caused to occur in a position shifted by a frequency difference Δf between the local oscillating frequency f_{L} and the desirable frequency f_{des} (a higher frequency position than the desirable frequency f_{des} by 2Δf) at an opposite side to the desirable frequency f_{des} as seen from the local oscillating frequency f_{L}. An FM modulating signal having the frequency relationship is frequency-shifted into a baseband signal so that the baseband signal is set to have a desirable frequency f_{des}′ and a frequency position having a certain frequency relationship therewith (a higher frequency position than the frequency f_{des}′ by 2Δf) is set to have an image frequency fᵢₘ′.

The structure of the detecting portion 7 shown in FIG. 1 is illustrative and the present invention is not restricted thereto. More specifically, it is sufficient that the detecting portion 7 can extract a low frequency signal containing an image component from a radio frequency FM modulating signal output from the power amplifier 4, and the detecting portion 7 does not need to always have the structure shown in FIG. 1. It is preferable to use the structure shown in FIG. 1 because a linearity of the detecting portion 7 can be enhanced.

The A/D converting portion 8 converts the baseband signal output from the detecting portion 7 from an analog signal into a digital signal. More specifically, the analog baseband signal output from the detecting portion 7 is converted into the digital signal through the A/D converting portion 8 and the digital signal is supplied to the DSP 1. Thus, a feedback to the DSP 1 is actually carried out in a form of the baseband signal obtained by reducing a frequency band of the FM modulating signal transmitted from the antenna 9 into a low frequency. For this reason, a high sampling frequency is not required as an operating clock for processing a feedback signal in the DSP 1. Therefore, a filtering calculation can easily be carried out through the BPF 15.

The BPF 15 corresponds to a filter portion according to the present invention and extracts an image frequency component from the baseband signal supplied from the A/D converting portion 8. The energy detecting portion 16 detects an energy (a power) of the image frequency component extracted from the BPF 15. As described above, the amplitude correcting portion 12 and the phase correcting portion 13 correct the amplitude and phase of the I signal generated by the signal processing portion 11 in such a manner that the energy detected by the energy detecting portion 16 is minimized.

For example, the amplitude correcting portion 12 first corrects the amplitude of the I signal generated by the signal processing portion 11 in such a manner that the energy detected by the energy detecting portion 16 is local minimum. Next, the phase correcting portion 13 corrects the phase of the I signal generated by the signal processing portion 11 in such a manner that the energy detected by the energy detecting portion 16 is minimized.

As described above in detail, according to the first embodiment, the image frequency component is extracted through the BPF 15 from the FM modulating signal generated by carrying out the quadrature modulation over the I and Q signals with the carrier signal, and the amplitude and the phase are corrected for the I signal in such a manner that the energy of the image frequency component is minimized. When the I and Q signals have no amplitude error and a phase difference between the I and Q signals is 90°, the energy of the image frequency component is minimized. By regulating the amplitude and phase of the I signal to minimize the energy, therefore, it is possible to set the amplitude and phase errors between the I and Q signals to be zero as a result. Consequently, it is not necessary to detect the amplitude and phase errors themselves between the I and Q signals and it is possible to accurately correct the amplitude and phase errors caused by a variation in an analog element in the 90° phase shifter 6, the mixer of the quadrature modulating portion 3 or the like, thereby enhancing the effect for removing the image component without an influence of a limit of precision in an error detection.

### Second Embodiment

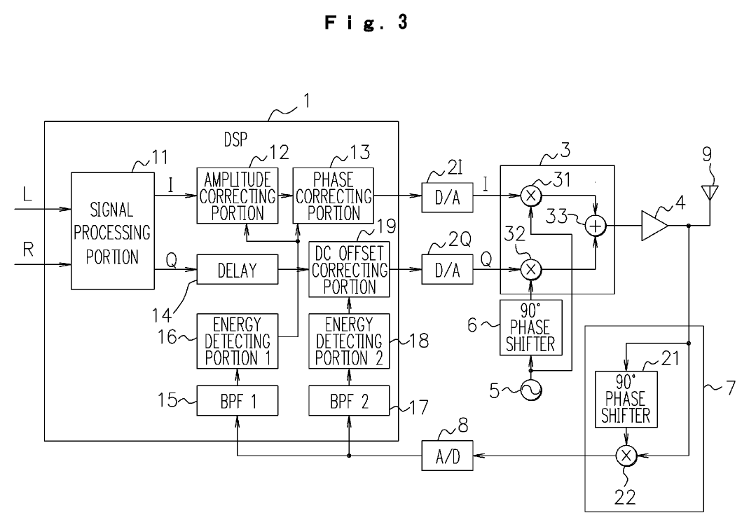

Next, a second embodiment according to the present invention will be described with reference to the drawings. FIG. 3 is a diagram showing an example of a structure of a transmitter according to the second embodiment. In FIG. 3, components having the same reference numerals as those shown in FIG. 1 have the same functions and repetitive description will be therefore omitted.

In FIG. 3, a DSP 1 includes a second BPF 17, an energy detecting portion 18 and a DC offset correcting portion 19 in addition to the functional structure shown in FIG. 1 as a functional structure to be implemented by a signal processing thereof.

The second BPF 17 corresponds to a second filter portion according to the present invention and extracts a carrier frequency component from a baseband signal (obtained by converting a signal output from a detecting portion 7 into a digital signal) supplied from an A/D converting portion 8. The second energy detecting portion 18 detects an energy (a power) of a carrier frequency component extracted by the second BPF 17.

The DC offset correcting portion 19 carries out a DC offset correction for a Q signal output from a delay processing portion 14 in such a manner that the energy detected by the second energy detecting portion 18 is minimized. More specifically, an amplitude value of the digital Q signal output from the delay processing portion 14 is increased or decreased by a predetermined offset quantity to minimize the energy of the carrier frequency component detected by the second energy detecting portion 18.

An operation of the transmitter according to the second embodiment having the structure described above is as follows, for example. First of all, an amplitude and a phase of an I signal are corrected to minimize an energy of an image frequency component detected by an energy detecting portion 16. Then, a DC offset correction is carried out for the Q signal in such a manner that the energy of the carrier frequency component detected by the second energy detecting portion 18 is minimized.

According to the second embodiment having such a structure, it is possible to accurately correct an amplitude error and a phase error which are caused by a variation in an analog element or the like, thereby enhancing the effect for removing an image component without an influence of a limit of detecting precision in the amplitude or phase errors of the I and Q signals. Furthermore, it is also possible to effectively suppress a DC offset (a carrier leakage) of the carrier frequency component.

Although the description has been given to the examples in which the amplitude and phase of the I signal is corrected in the first and second embodiments, the present invention is not restricted thereto. For example, it is also possible to correct the amplitude and phase of the Q signal. Moreover, it is also possible to correct the amplitude of one of the I and Q signals and the phase of the other. Furthermore, it is also possible to correct the amplitude and the phase for both of the I and Q signals. While the description has been given to the examples in which the amplitude is first corrected and the phase is then corrected in the first and second embodiments, the order of the correction may be reversed.

Although the description has been given to the example in which the DC offset is corrected for the Q signal in the second embodiment, the present invention is not restricted thereto. For example, it is also possible to correct the DC offset for the I signal or to correct the DC offset for both of the I and Q signals. While the description has been given to the example in which the image frequency component is first corrected and the carrier frequency component is then corrected in the second embodiment, the order of the correction may be reversed.

Although the description has been given to the examples in which the L and R digital audio signals are input to the signal processing portion 11 and the I and Q signals are generated from the input audio signal in the first and second embodiments, the correction may be carried out when the audio signal is not input. For example, it is also possible to constitute a normal operating mode and a correcting mode to be switchable and to prohibit the audio signal from being input to the signal processing portion 11 in the correcting mode. In this case, the signal processing portion 11 generates the I and Q signals from a predetermined reference signal generated in an inner part in the correcting mode. The reference signal may be a signal having an image frequency which is determined in a relationship between the sampling frequency of the audio signal and the local frequency of the local oscillator 5.

Although the description has been given to the structure in which the detecting portion 7 is provided in the first and second embodiments, the detecting portion 7 is not required in an environment in which a high speed clock can be used as the operating clock of the DSP 1. In the case in which the signal processing portion 11, the amplitude correcting portion 12, the phase correcting portion 13, the BPF 15 and the energy detecting portion 16 are constituted by an analog signal processing circuit in the first embodiment, for example, it is not necessary to reduce a frequency of an FM modulating signal into a low frequency in consideration of the operating clock of the DSP 1. Therefore, the detecting portion 7 and the A/D converting portion 8 are not required. Also in the second embodiment, the same structure can be employed.

Although the description has been given to the examples in which the quadrature modulating portion 3 outputs the FM modulating signal having the desirable frequency in the first and second embodiments, the quadrature modulating portion 3 may be constituted to output an AM modulating signal or a PM modulating signal.

In addition, the first and second embodiments are only illustrative for a concreteness to carry out the present invention and the technical range of the present invention should not be construed to be restrictive. In other words, the present invention can be carried out in various forms without departing from the spirit or main features thereof.

### INDUSTRIAL APPLICABILITY

The present invention is useful for a transmitter having a quadrature modulating function for distributing a baseband signal into an in-phase component and a quadrature component to carry out a modulation.

This application is based on Japanese Patent Application No. 2008-044008 filed on Feb. 26, 2008, the contents of which are incorporated hereinto by reference.

What is claimed is:

1. A transmitter comprising:
a signal processing portion for generating an in-phase signal and a quadrature signal having a perpendicular phase thereto;
a mixer portion for frequency mixing the in-phase and quadrature signals generated by the signal processing portion with in-phase and quadrature carrier signals, thereby generating a modulating signal having a desirable frequency;
a filter portion for extracting an image frequency component from the modulating signal generated by the mixer portion;
an energy detecting portion for detecting an energy of an image frequency component extracted by the filter portion; and
a correcting portion for correcting an amplitude and a phase for at least one of the in-phase signal and the quadrature signal in such a manner that the energy detected by the energy detecting portion is minimized.

2. The transmitter according to claim 1 further comprising a detecting portion for detecting the modulating signal generated by the mixer portion,
the filter portion extracting an image frequency component from an output signal of the detecting portion in place of the modulating signal generated by the mixer portion.

3. The transmitter according to claim 2, wherein the signal processing portion, the filter portion, the energy detecting portion and the correcting portion are constituted by a digital signal processing circuit,
the transmitter further comprising:
a D/A converting portion for converting the in-phase and quadrature signals generated by the signal processing portion from digital signals into analog signals, thereby supplying them to the mixer portion; and
an A/D converting portion for converting the output signal of the detecting portion from an analog signal into a digital signal, thereby supplying the digital signal to the filter portion.

4. The transmitter according to claim 2 further comprising:
a 90° phase shifter for shifting, by 90°, a phase of the modulating signal generated by the mixer portion and outputting the shifted modulating signal; and
a second mixer portion for frequency-mixing the modulating signal generated by the mixer portion with the modulating signal output from the 90° phase shifter and converting the modulating signal generated by the mixer portion into a signal having a baseband frequency.

5. The transmitter according to claim 1 further comprising:
a second filter portion for extracting a carrier frequency component from the modulating signal generated by the mixer portion;
a second energy detecting portion for detecting an energy of the carrier frequency component extracted by the second filter portion; and
a DC offset correcting portion for carrying out a DC offset correction over at least one of the in-phase signal and the quadrature signal in such a manner that the energy detected by the second energy detecting portion is minimized.

6. The transmitter according to claim 2 further comprising:
a second filter portion for extracting a carrier frequency component from the output signal of the detecting portion;
a second energy detecting portion for detecting an energy of the carrier frequency component extracted by the second filter portion; and
a DC offset correcting portion for carrying out a DC offset correction over at least one of the in-phase signal and the quadrature signal in such a manner that the energy detected by the second energy detecting portion is minimized.
